(19) United States
(12) Patent Application Publication
(10) Pub. No.: US 2010/0234527 A1
(43) Pub. Date: Sep. 16, 2010

(54) OPTICAL SEMICONDUCTOR ENCAPSULATING MATERIAL

(75) Inventors: Tsuyoshi Ota, Chiba (JP); Shinichi Yukimasa, Chiba (JP); Yutaka Obata, Chiba (JP); Tomoaki Takebe, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: IDEMITSU KOSAN CO., LTD., Chiyoda-ku (JP)

(21) Appl. No.: 12/299,015

(22) PCT Filed: Apr. 19, 2007
(86) PCT No.: PCT/JP07/58515

§ 371 Date: Oct. 30, 2008

(30) Foreign Application Priority Data
May 1, 2006 (JP) 2006-127631

(51) Int. Cl. C08F 2/38

(52) U.S. Cl. 524/853; 257/433; 257/E31.117

(57) ABSTRACT

The present invention provides a sealant material for an optical semiconductor containing (A) one or more kinds of a (meth)acrylic compound selected from a (meth)acrylate-modified silicone oil, a long chain alkyl (meth)acrylate, and a polylakylene glycol (meth)acrylate having the number average molecular weight of 400 or more, (B) a (meth)acrylate compound having an ester bond with an alicyclic hydrocarbon group having 6 or more carbon atoms, and (C) a radical polymerization initiator; and an optoelectronic conversion element and an optoelectronic conversion device using thereof. The sealant material for an optical semiconductor of the present invention provides a cured product having excellent characteristics in transparency, stability to UV light and heat, yellowing resistance, and adhesion performance, and thus may be suitably used as a sealant material for a light emitting element, a light receiving element and the like in an optical semiconductor device (semiconductor light emitting device), especially as a transparent sealant material for optical semiconductors such as LED and the like.

### TECHNICAL FIELD

The present invention relates to a sealant material for a light emitting element, a light receiving element and the like in an optical semiconductor device (a semiconductor light emitting device), an optoelectronic conversion element and an optoelectronic conversion device, in particular, to a transparent sealant material for an optical semiconductor, providing a cured product that has stability to a UV light and heat, yellowing resistance, and good adhesion performance, and an optoelectronic conversion element and an optoelectronic conversion device using the material.

### BACKGROUND ART

An optical semiconductor device (a semiconductor light emitting device) equipped with, as a light emitting element, a light-emitting diode (LED) chip having a light emitting layer composed of a bonding region of a p-n bond formed in a semiconductor layer developed on a crystal substrate, is used widely in various display devices, display instruments and the like.

As an example of this optical semiconductor device, there may be mentioned a visible light emitting device and an electronic device operational at high temperature using gallium nitride compound semiconductors such as GaN, GaAlN, InGaN, InAlGaN and the like, and recently the development is progressing in the fields of a blue light emitting diode and a ultra-violet light emitting diode.

An optical semiconductor device equipped with an LED chip as a light emitting element is mounted with an LED chip on the light emitting side of a lead frame, wherein the LED chip and the lead frame are electrically connected by a wire bonding and further they are sealed by a resin having properties of protecting the light emitting element as well as functioning as a lens.

In recent years, a white LED has attracted attention as a new light source, and it is said that the market will greatly expand around an illumination use in the days ahead. A white LED is put into practical use as a type in which a GaN bear chip is coated with a YAG fluorescent body to emit a white light by mixing a blue emitting light of GaN and a yellow emitting light of the fluorescent body and as a type in which three chips of red, green and blue are put in a single package to emit a white light. Further in recent years, in view of improving a color tone, a method in which plural fluorescent bodies are combined together using a UV LED chip as a light source is also developed. Further, in order to use an LED in an illumination use and the like, improvement of the durability is required.

On the other hand, as a sealant material to seal a light emitting element such as a light emitting diode (LED) chip and the like, an epoxy resin is used in many cases. An epoxy resin is used because of the transparency, the good processability and the like. Generally, an epoxy resin used as a sealant for an LED is composed of, in most cases, bisphenol A glycidyl ether, methylhexahydrophthalic anhydride, and a curing accelerator such as an amine type, a phosphorous type or the like. However, these components form a carbonyl group by absorption of a UV light, and thus had a problem of yellowing caused by absorption of a visible light. In order to solve this problem, a method of using hydrogenated bisphenol A glycidyl ether was proposed (Non-Patent Document 1), but the performance is not necessarily adequate.

In order to overcome the problems of yellowing and decrease of brightness due to a UV light, a silicone resin is widely used. A silicone resin is excellent in transparency in a UV region, and is almost resistant to yellowing and to decrease of transmittance due to a UV light. However, in a silicone resin there have been problems of low light extraction efficiency because of the low refractive index and of poor adhesion with a lead frame and a reflector because of the low polarity.

Further, in an LED of a surface-mounted type, soldering by a reflow solder system is applied. In a reflow furnace, it is exposed to heat at 260° C. for about 10 seconds, therefore, the shape distortion and cracking by heat may occur in conventional epoxy resins and silicone resins.

Meanwhile, in Patent Document 1, it is disclosed that a polymer having excellent optical characteristics, heat resistance, and water resistance may be obtained by homo-polymerizing or co-polymerizing an alicyclic acrylate ester or methacrylate ester having 10 or more carbon atoms. As the use of these polymers, a sealant for a light emitting diode is described, but further improvement in adhesion performance and the like is required.
Patent Document 1: Japanese Patent Laid-Open Publication No. H02-67248
Non-Patent Document 1: NEDO's “Development of Compound Semiconductors for High Efficiency Optoelectronic Conversion, Accomplishment Report, Light for the 21^{st} Century Project in the fiscal 2001”

### DISCLOSURE OF THE INVENTION

### Problems to be Solved by the Invention

In view of the above situation, an object of the present invention is to provide a transparent sealant material for an optical semiconductor, providing a cured product that has stability to a UV light and heat, yellowing resistance, and good adhesion performance, an optoelectronic conversion element and an optoelectronic conversion device.

### Means for Solving the Problems

Inventors of the present invention carried out extensive investigation to accomplish the object as mentioned above, and as a result, found that a sealant material for an optical semiconductor, containing a (meth)acrylate compound selected from a (meth)acrylate-modified silicone oil, a long chain alkyl(meth)acrylate and a polyalkylene glycol(meth)acrylate, a (meth)acrylate compound having an ester bond with an alicyclic hydrocarbon group having 6 or more carbon atoms, and a radical polymerization initiator, was in accord with the objects as mentioned above. The present invention was accomplished based on these findings thus obtained.

Namely, the present invention is to provide a sealant material for an optical semiconductor, an optoelectronic conversion element, and an optoelectronic conversion device as shown in the following.
1. A sealant material for an optical semiconductor, comprising: (A) one or more kinds of a (meth)acrylate compound selected from a (meth)acrylate-modified silicone oil, a long chain alkyl(meth)acrylate, and a polyalkylene glycol(meth)acrylate having the number average molecular weight of 400 or more; (B) a (meth)acrylate compound having an ester bond with an alicyclic hydrocarbon group having 6 or more carbon atoms; and (C) a radical polymerization initiator.
2. The sealant material for an optical semiconductor according to the above 1, wherein the component (B) is a (meth)acrylate compound having an ester bond with one or more kinds of an alicyclic hydrocarbon group selected from an adamantyl group, a norbornyl group, an isobornyl group, and a dicyclopentanyl group.
3. The sealant material for an optical semiconductor according to the above 1 or 2, wherein the component (A) is hydrogenated polybutadiene diacrylate and/or polyethylene glycol di(meth)acrylate having the number average molecular weight of 400 or more.
4. An optoelectronic conversion element comprising using the sealant material for an optical semiconductor according to any of the above 1 to 3.
5. An optoelectronic conversion device comprising using the optoelectronic conversion element according to the above 4.

### Effects of the Invention

A sealant material for an optoelectronic semiconductor of the present invention provides a cured product having excellent characteristics in transparency, stability to a UV light and heat, yellowing resistance, and adhesion performance, and may be suitably used as a sealant material for a light emitting element, a light receiving element and the like in an optical semiconductor device (a semiconductor light emitting device), especially as a transparent sealant material for an optical semiconductor such as LED and the like.

### BRIEF DESCRIPTION OF THE DRAWINGS

FIG. 1 is an explanatory drawing of an instrument to measure the number of adhered reflectors in the adhesion test of the Examples.

### BEST MODE FOR CARRYING OUT THE INVENTION

A sealant material for an optical semiconductor in the present invention contains (A) one or more kinds of a (meth)acrylate compound selected from a (meth)acrylate-modified silicone oil (a-1), a long chain alkyl (meth)acrylate (a-2), and a polyalkylene glycol (meth)acrylate (a-3) having the number average molecular weight of 400 or more, (B) a (meth)acrylate compound having an ester bond with an alicyclic hydrocarbon group having 6 or more carbon atoms, and (C) a radical polymerization initiator.

Firstly, the (meth)acrylate-modified silicone oil (a-1) in the component (A) is a compound having an acryl group and/or a methacryl group at the terminal and containing a dialkyl polysiloxane skeleton. This (meth)acrylate-modified silicone oil (a-1) in the component (A) is a modified compound of dimethyl polysiloxane in many cases, but all or part of the alkyl groups in the dialkyl polysiloxane skeleton may be replaced by an alkyl group other than a phenyl group and a methyl group in place of the methyl group. As the alkyl group other than a methyl group, an ethyl group, a propyl group and the like may be mentioned. Specific examples of them include X-24-8201, X-22-174DX, X-22-2426, X-22-2404, X-22-164A and X-22-164C, all manufactured by Shin-Etsu Chemical Co., Ltd., and BY16-152D, BY16-152, BY-152C and the like, all manufactured by Dow Corning Toray Co., Ltd.

Furthermore, as the (meth)acrylate-modified silicone oil (a-1) in the component (A), a polydialkyl siloxane having an acryloxy alkyl terminal or a methacryloxy alkyl terminal may be used, and specific examples of them include methacryloxypropyl-terminated polydimethyl siloxane, (3-acryloxy-2-hydroxypropyl)-terminated polydimethyl siloxane, acryloxy-terminated ethylene oxide dimethyl siloxane-ethylene oxide ABA block copolymer, methacryloxypropyl-terminated branched polydimethyl siloxane and the like.

Among them, in view of the transparency after curing, (3-acryloxy-2-hydroxypropyl)-terminated polydimethyl siloxane and acryloxy-terminated ethylene oxide dimethyl siloxane-ethylene oxide ABA block copolymer are suitably used.

As the long chain alkyl(meth)acrylate (a-2) in the component (A), there may be mentioned hydrogenated polybutadiene such as hydrogenated polybutadiene diacrylate, hydrogenated polyisoprene diacrylate and the like, an acryl or a methacryl compound having a hydrogenated polyisoprene skeleton, and (meth)acrylate compounds having an alkyl group having 12 or more carbon atoms such as stearyl methacrylate and the like. Examples of the alkyl group having 12 or more carbon atoms include a dodecyl group, a tetradecyl group, a hexadecyl group, an octadecyl group (including a stearyl group), an eicosyl group, a triacontyl group and a tetracontyl group. By using an alkyl group having 12 or more carbon atoms, an excellent adhesion performance may be obtained.

Among these compounds, in view of the adhesion performance, hydrogenated polybutadiene diacrylate and stearyl methacrylate are preferable, and hydrogenated polybutadiene diacrylate is particularly preferable.

As the polyalkylene glycol (meth)acrylate (a-3) having the number average molecular weight of 400 or more in the component (A), there may be mentioned polyethylene glycol monomethacrylate, polypropylene glycol monomethacrylate, polybutylene glycol monomethacrylate, polyethylene glycol di(meth)acrylate, polypropylene glycol dimethacrylate, polybutylene glycol dimethacrylate and the like. By using hydrogenated polybutadiene diacrylate and/or polyethylene glycol di(meth)acrylate having the number average molecular weight of 400 or more as the polyalkylene glycol (meth)acrylate having the number average molecular weight of 400 or more, excellent toughness and adhesion performance may be obtained. Especially, polyethylene glycol di(meth)acrylate having the number average molecular weight of 400 or more may be mentioned as the suitable component. The maximum value of the number average molecular weight is not particularly restricted, but the one having the number average molecular weight of 10,000 or less is preferably used in view of the compatibility with the component (B).

In the present invention, as the component (A), at least one kind selected from the component (a-1), at least one kind selected from the component (a-2), or at least one kind selected from the component (a-3) may be used, or an combination appropriately selected from the component (a-1), the component (a-2) and the component (a-3) may also be used.

As the alicyclic hydrocarbon group of the (meth)acrylate compound having an ester bond with an alicyclic hydrocarbon group having 6 or more carbon atoms in the component (B), there may be mentioned a cyclohexyl group, a 2-decahydronaphthyl group, an adamantyl group, a 1-methyladamantyl group, a 2-methyladamantyl group, a biadamantyl group, a dimethyladamantyl group, a norbornyl group, a 1-methyl-norbornyl group, 5,6-diemethyl-norbornyl group, an isobornyl group, a tetracyclo[4.4.0.1^{2,5}.1^{7,10}]dodecyl group, a 9-methyl-tetracyclo[4.4.0.1^{2,5}.1^{7,10}]dodecyl group, a bornyl group, a dicyclopentanyl group and the like. Among them, an adamantyl group, a norbornyl group, an isobornyl group, and a dicyclopentanyl group are preferable. Among them, an adamantyl group is further preferable and a 1-adamantyl group is particularly preferable.

As the (meth)acrylate compound in the component (B) used in the sealant material for an optical semiconductor of the present invention, there may be mentioned the (meth)acrylate having the above-mentioned alicyclic hydrocarbon group such as cyclohexyl acrylate, cyclohexyl methacrylate, 1-adamantyl(meth)acrylate, norbornyl(meth)acrylate, isobornyl(meth)acrylate, dicyclopentanyl(meth)acrylate and the like. In the present invention, the afore-mentioned (meth)acrylate may be used singly or in combination of two or more kinds as the component (B).

In the present invention, by using the alicyclic hydrocarbon group having 6 or more carbon atoms, excellent heat resistance may be obtained. In addition, since the ester substituent is an alicyclic hydrocarbon group and does not contain an aromatic group and the like, the deterioration due to a UV light hardly occurs.

When compared with a (meth)acrylate compound having an ester bond with an aliphatic hydrocarbon group only containing single bonds, a (meth)acrylate compound having an ester bond with an aromatic group and an alicyclic hydrocarbon group has better heat resistance. Since the component (B) used in the sealant material for an optical semiconductor of the present invention has an alicyclic structure, absorption of the light in the UV region is smaller as compared with a similar compound having an aromatic structure. Accordingly, the deterioration due to UV light hardly occurs. In addition, since there is no double bond, the deterioration due to oxidation may hardly occur, which contributes to the UV resistance.

Here, polycyclic groups combining two or more alicyclic hydrocarbon groups, such as an adamantyl group, a norbornyl group, an isobornyl group, and a dicyclopentanyl group, are more preferable as they are further resistant to deterioration due to oxidation and heat.

And, an adamantyl group is particularly preferable in the heat resistance and the UV resistance, since it has three six-membered rings combined together to form a stable polycyclic structure.

The ratio of the component (A) to the component (B) in the sealant material for an optical semiconductor of the present invention is preferably 10 to 80% by mass and more preferably 15 to 70% by mass of the component (A) based on the total mass of the component (A) and the component (B). When the content of the component (A) is 10% or more by mass, the excellent adhesion performance and the toughness are obtained, and when it is 80% or less by mass, the excellent rigidity and the heat resistance are obtained.

As the radical polymerization initiator of the component (C), there may be mentioned ketone peroxides such as methyl ethyl ketone peroxide, methyl isobutyl ketone peroxide, acetylacetone peroxide, cyclohexanone peroxide, methylcyclohexanone peroxide and the like; hydroperoxides such as 1,1,3,3-tetramethylbutyl hydroperoxide, cumene hydroperoxide, t-butyl hydroperoxide and the like; diacyl peroxides such as diisobutylyl peroxide, bis-3,5,5-trimethylhexanol peroxide, lauroyl peroxide, benzoyl peroxide, m-toluylbenzoyl peroxide and the like; dialkyl peroxides such as dicumyl peroxide, 2,5-dimethyl-2,5-di(t-butylperoxy)hexane, 1,3-bis(t-butylperoxyisopropyl)hexane, t-butylcumyl peroxide, di-t-butyl peroxide, 2,5-dimethyl-2,5-di(t-butylperoxy)hexene and the like; peroxyketals such as 1,1-di(t-butylperoxy-3,5,5-trimethyl)cyclohexane, 1,1-di-t-butylperoxycyclohexane, 2,2-di(t-butylperoxy)butane and the like; alkyl peresters such as 1,1,3,3-tetramethylbutylperoxy neodicarbonate, α-cumylperoxy neodicarbonate, t-butylperoxy neodicarbonate, t-hexylperoxy pivalate, t-butylperoxy pivalate, 1,1,3,3-tetramethylbutylperoxy 2-ethylhexanoate, t-amylperoxy 2-ethylhexanoate, t-butylperoxy 2-ethylhexanoate, t-butylperoxy isobutylate, di-t-butylperoxy hexahydroterephthalate, 1,1,3,3-tetramethylbutylperoxy 3,5, 5-trimethylhexanate, t-amylperoxy 3,5,5-trimethylhexanoate, t-butylperoxy 3,5,5-trimethylhexanoate, t-butylperoxy acetate, t-butylperoxy benzoate, dibutylperoxy trimethyladipate and the like; peroxycarbonates such as di-3-methoxybutylperoxy dicarbonate, di-2-ethylhexylperoxy dicarbonate, bis(1,1-butylcyclohexaoxy dicarbonate), diisopropyloxy dicarbonate, t-amylperoxy isopropyl carbonate, t-butylperoxy isopropyl carbonate, t-butylperoxy 2-ethylhexyl carbonate, 1,6-bis(t-butylperoxycarboxy)hexane and the like; an azo compound such as 2,2′-azobisisobutyronitrile and the like; and further 1,1-bis(t-hexylperoxy)cyclohexane and (4-t-butylcyclohexyl)peroxy dicarbonate, both of which are used in Examples; and others.

The amount of the component (C) used for the radical polymerization initiator is usually 0.01 to 5 parts by mass and preferably 0.05 to 2 parts by mass, relative to 100 parts by mass of the total amount of the monomer components. Each of the radical polymerization initiators may be used singly or in combination.

Here, the total amount of the monomer components in the present invention is the total amount of the component (A), the component (B), and the component (D) [other (meth)acrylate compound] which will be mentioned later.

In the sealant material for an optical semiconductor of the present invention, in addition to the radical polymerization initiators as mentioned above, publicly known antioxidants, light stabilizers and the like may also be used. As the antioxidant, there may be mentioned a phenolic antioxidant, a phosphorous antioxidant, a sulfur antioxidant, a vitamin antioxidant, a lactone antioxidant, an amine antioxidant and the like.

An example of the phenolic antioxidant includes a commercially available antioxidant such as Irganox 1010 (trademark, manufactured by Ciba Specialty Chemicals Inc.), Irganox 1076 (trademark, manufactured by Ciba Specialty Chemicals Inc.), Irganox 1330 (trademark, manufactured by Ciba Specialty Chemicals Inc.), Irganox 3114 (trademark, manufactured by Ciba Specialty Chemicals Inc.), Irganox 3125 (trademark, manufactured by Ciba Specialty Chemicals Inc.), Irganox 3790 (trademark, manufactured by Ciba Specialty Chemicals Inc.), BHT, Cyanox 1790 (trademark, manufactured by Cyanamid Co.), Sumilizer GA-80 (trademark, manufactured by Sumitomo Chemical Co., Ltd.) and the like.

An example of the phosphorous antioxidant includes a commercially available antioxidant such as Irgafos 168 (trademark, manufactured by Ciba Specialty Chemicals Inc.), Irgafos 12 (trademark, manufactured by Ciba Specialty Chemicals Inc.), Irgafos 38 (trademark, manufactured by Ciba Specialty Chemicals Inc.), ADK STAB 329K (trade mark, manufactured by Asahi Denka Co., Ltd.), ADK STAB PEP36 (trademark, manufactured by Asahi Denka Co., Ltd.), ADK STAB PEP-8 (trademark, Asahi Denka Co., Ltd.), Sardstab P-EPQ (trademark, manufactured by Clariant Corp.), Weston 618 (trademark, manufactured by General Electric Company), Weston 619G (trademark, manufactured by General Electric Company), Weston 624 (trademark, manufactured by General Electric Company) and the like.

An example of the sulfur antioxidant includes a commercially available antioxidant such as DSTP (Yoshitomi) (trademark, manufactured by Yoshitomi Pharmaceutical Co., Ltd.), DLTP (Yoshitomi) (trademark, manufactured by Yoshitomi Pharmaceutical Co., Ltd.), DLTOIB (trademark, manufactured by Yoshitomi Pharmaceutical Co., Ltd.), DMTP (Yoshitomi) (trademark, manufactured by Yoshitomi Pharmaceutical Co., Ltd.), Seenox 412S (trademark, manufactured by Shipro Kasei, Ltd.), Cyanox 1212 (trademark, manufactured by Cyanamid Co.) and the like.

An example of the vitamin antioxidant includes a commercially available antioxidant such as tocopherol, Irganox E201 (trademark, manufactured by Ciba Specialty Chemicals Inc., compound name: 2,5,7,8-tetramethyl-2(4′,8′,12′-trimethyltridecyl)cumaron-6-ol) and the like.

An example of the lactone antioxidant includes an antioxidant disclosed in Japanese Patent Laid-Open Publication No. H07-233160 and Japanese Patent Laid-Open Publication No. H07-247278. Further, HP-136 (trademark: manufactured by Ciba Specialty Chemicals Inc., compound name: 5,7-di-t-butyl-3-(3,4-dimethylphenyl)-3H-benzofuran-2-on) and the like may be mentioned.

An example of the amine antioxidant includes a commercially available antioxidant such as Irgastab FSO42 (trademark, manufactured by Ciba Specialty Chemicals Inc.), GENOX EP (trademark, manufactured by Crompton Corp., compound name: dialkyl-N-methylamine oxide) and the like.

When these additives are used, the use amount is usually 0.005 to 5 parts by mass and preferably 0.02 to 2 parts by mass, relative to the total amount 100 parts by mass of the monomer components. They may be used in combination of two or more kinds.

Further, the sealant material for an optical semiconductor of the present invention may be added by a light stabilizer. As the light stabilizer, a generally known substance may be used, but a hindered amine light stabilizer is preferable. Specific examples of them, in commercial names, include ADK STAB LA-52, LA-57, LA-62, LA-63, LA-67, LA-68, LA-77, LA-82, LA-87 and LA-94, all manufactured by Asahi Denka Co., Ltd., Tinuvin 123, 144, 440, 662, Chimassorb 2020, 119 and 944, all manufactured by Ciba Specialty Chemicals Inc., Hostavin N30 manufactured by Hoechst GmbH, Cyasorb UV-3346 and UV-3526, both manufactured by Cytec Industries Inc., Uval 299 manufactured by Great Lakes Chemical Corp., Sanduvor PR-31 manufactured by Clariant Corp., and the like.

When these light stabilizers are used, the use amount is usually 0.005 to 5 parts by mass and preferably 0.002 to 2 parts by mass, relative to the total amount 100 parts by mass of the monomer components. They may be used in combination of two or more kinds. Further, various kinds of fluorescent bodies may also be added.

In the sealant material for an optical semiconductor of the present invention, in order to obtain high strength, one or more kinds of other (meth)acrylate compound ((meth)acrylate compounds other than the component (A) and the component (B)) may be added as the component (D). As the (meth)acrylate compounds in the component (D), there may be mentioned ethylene glycol di(meth)acrylate, propylene glycol di(meth)acrylate, 1,4-butanediol (meth)acrylate, 1,6-hexanediol di(meth)acrylate, 1,9-nonanediol di(meth)acrylate, neopentyldiol di(meth)acrylate, polyethylene glycol di(meth)acrylate and polypropylene glycol di(meth)acrylate whose number average molecular weights are less than 400, alkoxy polyalkylene glycol(meth)acrylate such as methoxy polyethylene methacrylate and the like, ethylene oxide-modified bisphenol A di(meth)acrylate, propylene oxide-modified bisphenol A di(meth)acrylate, epichlorohydrin-modified bisphenol A di(meth)acrylate, propylene oxide-modified glycerine tri(meth)acrylate, trimethylolpropane tri(meth)acrylate, ditrimethylolpropane tetra(meth)acrylate, dipentaerythritol hexa(meth)acrylate, tris(acryloyloxyethyl)isocyanurate, methoxypolyethylene glycol(meth)acrylate, and the like.

The amount of the (meth)acrylate compound of the component (D) is 50% or less by mass relative to the total amount of the component (A) and the component (B).

In the present invention, the sealant material for an optical semiconductor may be prepared by pre-polymerizing the component (B) to adjust the viscosity in advance and then by blending the resulting component (B) with the component (A) and the like. The pre-polymerization may be performed by adding a radical polymerization initiator of the component (C) mentioned above to a (meth)acylate compound of the component (B) mentioned above. By blending the viscosity-adjusted component (B) as the component of the sealant material for an optical semiconductor of the present invention, the viscosity of the entire sealant material for an optical semiconductor may be adjusted, as a result, the curing process thereafter may be facilitated.

The amount of the radical polymerization initiator to be added is not particularly restricted, but it is usually 10 to 20,000 ppm and preferably 50 to 10,000 ppm, relative to the component (B). When the amount is 10 ppm or more, the pre-polymerization surely progresses, and when the amount is 20,000 ppm or less, the reaction is easily controlled. Further, in order to control the reaction precisely, an inert solvent may be present at the time of the pre-polymerization reaction.

Further, at the time of pre-polymerization, one or more kinds of only the component (B) may be used, or the component (B) may be used in combination with a radical polymerizable compound other than the component (B). Preferably, the amount of the (meth)acrylate compound containing an alicyclic hydrocarbon group having 6 or more carbon atoms is 10% or more by mass. When the amount is 10% or more by mass, the decrease of rigidity and heat resistance may be avoided.

As the solvent for the pre-polymerization, a solvent used in a general radical polymerization may be used. Specific examples of them include ethers such as tetrahydrofuran and the like; ketones such as methyl ethyl ketone and the like; aromatic hydrocarbons such as toluene and the like; saturated hydrocarbons such as hexane, cyclohexane and the like; esters such as ethyl acetate and the like; halogenated hydrocarbons such as trichloromethane and the like. Among them, a solvent which can dissolve a polymer produced by the pre-polymerization is suitable. As the specific examples of such solvents, there may be mentioned tetrahydrofuran, toluene, trichloromethane and the like.

When a solvent is used in the pre-polymerization, it is preferable to remove the solvent by distillation or reduced pressure after the pre-polymerization. In such a case, the amount of the residual solvent is preferably 5% or less by mass, and more preferably 1% or less by mass. When the amount of the residual solvent is 5% or less by mass, foam-formation and the like may be avoided at the time of curing of the sealant material.

Temperature during the pre-polymerization is dependent on the kind of the radical polymerization initiator, but usually 0 to 150° C., and preferably 20 to 100° C. Further, the viscosity of a mixture composed of a polymer produced by the pre-polymerization and a monomer is usually 100 to 10,000 mPa·s and preferably 200 to 5,000 mPa·s.

As the method for terminating the pre-polymerization, a method of decreasing the temperature in the polymerization reaction system, introducing an air or an oxygen gas into the system, adding a polymerization inhibitor such as hydroquinone monomethyl ether and the like, or others may be employed.

The sealant material for an optical semiconductor of the present invention provides a cured product by heat-treating it at the temperature to generate radicals from the component (C) or higher. The curing condition may be appropriately determined by considering the above. The elements to be sealed by the material are not particularly restricted, and there may be mentioned, for instance, a light emitting diode (LED) chip, a semiconductor laser, a photo-diode, a photo-interrupter, a photo-coupler, a photo-transistor, an electroluminescence element, a CCD, a solar cell, and the like. As the optoelectronic conversion element of the present invention, there may be mentioned an LED and the like sealed by the sealant material for an optical semiconductor of the present invention, and as the optoelectronic conversion device of the present invention, there may be mentioned various kinds of semiconductor devices such as illuminating devices, traffic signals and the like using the LED.

### Examples

In the following, the present invention will be explained more specifically by Examples, but the present invention is not restricted by these Examples at all.

Here, physical properties of the sealant material for an optical semiconductor and the cured product obtained in each Example and Comparative Example were evaluated in the following methods. The number average molecular weights were measured by NMR.

### (1) Total Light Transmittance

Total light transmittance was measured in accordance with JIS K7105 by using a specimen of 3-mm thickness as the test sample (unit: %). The instrument HGM-2DP (manufactured by Suga Test Instruments Co., Ltd.) was used for the measurement.

Further, the sample was kept in an oven thermostated at 140° C. for 100 hours, and the difference (%) between the total light transmittances before and after the test was taken as the Δ total light transmittance.

### (2) Weatherability Test (Measurement of the Yellow Index)

The yellow index (YI) was measured in accordance with JIS K7105 by using a specimen of 3-mm thickness as the test sample. The measurement instrument SZ-optical SENSOR (manufactured by Nippon Denshoku Industries Co., Ltd.) was used for the following weatherability tests.
ΔYI¹: By using a weatherability test instrument (solarbox 1500e, manufactured by JASCO International Co., Ltd.), a UV light was irradiated to the sample at 500 W/m² for 100 hours to measure YI. The difference between YIs before and after the UV irradiation was taken as ΔYI¹.
ΔYI²: The sample was kept in an oven thermostated at 140° C. for 100 hours, and the difference between YIs before and after the test was taken as ΔYI².

### (3) Haze

Initial Haze value (%): this was measured in accordance with JIS K7105 by a totally automated direct reading Haze computer HGM-2DP (a C light source) (manufactured by Suga Test Instruments Co., Ltd.)

Also, the sample was kept in an oven thermostated at 140° C. for 100 hours, and the difference (%) between Hazes before and after the test was taken as ΔHaze.

### (4) Adhesion Test (Number of Adhered Reflectors)

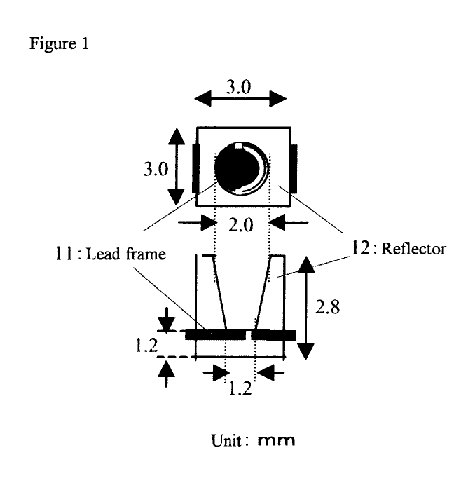

A polyamide composite material and a lead frame were integrally molded to prepare 10 components as shown in FIG. 1. A curable sealant material (liquid) for an optical semiconductor was filled in the dent part of the component, and thermally cured under the prescribed conditions. Each component was checked and the state of the adhesion between the cured product and the reflector was observed. The adhesion performance was evaluated by counting unpeeled components among the 10 components.

Here, the polyamide composite material prepared as following was used; a semi-aromatic polyamide (AMODEL A4000, manufactured by Solvay Advanced Polymers K.K.), titanium oxide (PF-726, manufactured by Ishihara Sangyo Kaisha Ltd.), and glass fibers (JAFT164G manufactured by Asahi Fiber Glass Co., Ltd.) were dry-blended at the ratio of 70/10/20 by mass, and the resulting blend was charged into a hopper of a biaxial extruder with 30-mm inner diameter, melt-kneaded at the barrel temperature of 285° C., and then molded in pallets.

### Example 1

A batch containing 25 g of 1-adamantyl methacrylate (manufactured by Osaka

Organic Chemical Industry Ltd.) as the component (B) and 25 g of polyethylene glycol #400 dimethacrylate (a-3) (trade name: NK Ester 9G, number average molecular weight: 540, manufactured by Shin-Nakamura Chemical Co., Ltd.) as the component (A) was added and mixed with 0.2 g of 1,1-bis(t-hexylperoxy)cyclohexane (trade name: Perhexa HC, manufactured by NOF CORPORATION) and 0.2 g of bis(4-t-butylcyclohexyl)peroxy dicarbonate (trade name: Peroyl TCP, manufactured by NOF CORPORATION) as the component (C) to obtain a curable sealant material for an optical semiconductor. The curable sealant material for an optical semiconductor thus obtained was charged into a cell prepared by sandwiching a Teflon (trademark) spacer having 3-mm thickness between two glass plates or into the dent part of the component shown in FIG. 1, heated at 70° C. for 3 hours and at 160° C. for 1 hour in an oven, and then cooled to room temperature to obtain a colorless and transparent cured product in a plate shape. The evaluation results on the physical properties of the sealant material for a semiconductor and of the cured product thus obtained are shown in Table 1.

### Example 2

A batch containing 25 g of 1-adamantyl methacrylate (manufactured by Osaka Organic Chemical Industry Ltd.) as the component (B) and 25 g of hydrogenated polybutadiene diacrylate (a-2) (trade name: SPBDA S30, manufactured by Shin-Etsu Chemical Co., Ltd.) as the component (A) was added and mixed with 0.2 g of 1,1-bis(t-hexylperoxy)cyclohexane (trade name: Perhexa HC, manufactured by NOF CORPORATION) and 0.2 g of bis(4-t-butylcyclohexyl)peroxy dicarbonate (trade name: Peroyl TCP, manufactured by NOF CORPORATION) as the component (C) to obtain a curable sealant material for an optical semiconductor. The curable sealant material for an optical semiconductor thus obtained was charged into a cell prepared by sandwiching a Teflon (trademark) spacer having 3-mm thickness between two glass plates or into the dent part of the component shown in FIG. 1, heated at 70° C. for 3 hours and at 160° C. for 1 hour in an oven, and then cooled to room temperature to obtain a colorless and transparent cured product in a plate shape. The evaluation results on the physical properties of the sealant material for a semiconductor and of the cured product thus obtained are shown in Table 1.

### Example 3

A batch containing 25 g of 1-adamantyl methacrylate (manufactured by Osaka Organic Chemical Industry Ltd.) as the component (B) and 25 g of (3-acryloxy-2-hydroxypropyl)-terminated polydimethylsiloxane (a-1) (trade name: DMS-U22, manufactured by AZmax Co.) as the component (A) was added and mixed with 0.2 g of 1,1-bis(t-hexylperoxy)cyclohexane (trade name: Perhexa HC, manufactured by NOF CORPORATION) and 0.2 g of bis(4-t-butylcyclohexyl)peroxy dicarbonate (trade name: Peroyl TCP, manufactured by NOF CORPORATION) as the component (C) to obtain a curable sealant material for an optical semiconductor. The curable sealant material for an optical semiconductor thus obtained was charged into a cell prepared by sandwiching a Teflon (trademark) spacer having 3-mm thickness between two glass plates or into the dent part of the component shown in FIG. 1, heated at 70° C. for 3 hours and at 160° C. for 1 hour, and then cooled to room temperature to obtain a colorless and transparent cured product in a plate shape. Physical properties of the sealant material for the semiconductor and the cured product thus obtained were evaluated and the results are shown in Table 1.

### Example 4

A batch containing 25 g of 1-adamantyl methacrylate (manufactured by Osaka Organic Chemical Industry Ltd.) as the component (B), and 5 g of polyethylene glycol #400 dimethacrylate (a-3) (trade name: NK Ester 9Q number-average molecular weight: 540, manufactured by Shin-Nakamura Chemical Co., Ltd.) and 20 g of stearyl methacrylate (a-2) (manufactured by Mitsubishi Rayon Co., Ltd.) as the component (A) was added and mixed with 0.2 g of 1,1-bis(t-hexylperoxy)cyclohexane (trade name: Perhexa HC, manufactured by NOF CORPORATION) and 0.2 g of bis(4-t-butylcyclohexyl)peroxy dicarbonate (trade name: Peroyl TCP, manufactured by NOF CORPORATION) as the component (C) to obtain a curable sealant material for an optical semiconductor. The curable sealant material for an optical semiconductor thus obtained was charged into a cell prepared by sandwiching a Teflon (trademark) spacer having 3-mm thickness between two glass plates or into the dent part of the component shown in FIG. 1, heated at 70° C. for 3 hours and at 160° C. for 1 hour in an oven, and then cooled to room temperature to obtain a colorless and transparent cured product in a plate shape. The evaluation results on the physical properties of the sealant material for the semiconductor and of the cured product thus obtained are shown in Table 1.

### Example 5

A batch containing 50 g of 1-adamantyl methacrylate (manufactured by Osaka Organic Chemical Industry Ltd.) as the component (B) and 50 g of methoxypolyethylene glycol #400 methacrylate (trade name: NK Ester M-90G; number average molecular weight: 470, manufactured by Shin-Nakamura Chemical Co., Ltd.) as the component (D) was added by 100 ppm of (4-t-butylcyclohexyl) peroxy dicarbonate (trade name: Peroyl

TCP, manufactured by NOF CORPORATION) as the component (C), and the reaction was carried out under a nitrogen atmosphere at 60° C. for 2 hours. The viscosity of the pre-polymerized syrup thus obtained was 600 mPa·s.

Into 25 g of this syrup were added and mixed 12.5 g of 1-adamantyl methacrylate (manufactured by Osaka Organic Chemical Industry Ltd.) as the component (B), 12.5 g of polyethylene glycol #400 dimethacrylate (a-3) (trade name: NK Ester 9G, number average molecular weight: 540, manufactured by Shin-Nakamura Chemical Co., Ltd.) as the component (A), and 0.2 g of 1,1-bis(t-hexylperoxy)cyclohexane (trade name: Perhexa HC, manufactured by NOF CORPORATION) and 0.2 g of (4-t-butylcyclohexyl)peroxy dicarbonate (trade name: Peroyl TCP, manufactured by NOF CORPORATION) as the component (C) to obtain a curable sealant material for an optical semiconductor. The curable sealant material for an optical semiconductor thus obtained was charged into a cell prepared by sandwiching a Teflon (trademark) spacer having 3-mm thickness between two glass plates or into the dent part of the component shown in FIG. 1, heated at 70° C. for 3 hours and at 160° C. for 1 hour in an oven, and then cooled to room temperature to obtain a colorless and transparent cured product in a plate shape. The evaluation results on the physical properties of the sealant material for a semiconductor and of the cured product thus obtained are shown in Table 1.

Here, the present Example represents the case when the component (D) and part of the component (B) are pre-polymerized, and * in Table 1 shows the amount used in the pre-polymerization.

### Comparative Example 1

Into 14 g of bisphenol A liquid epoxy resin monomer (trade name: Epikote 828, manufactured by Japan Epoxy Resins Co., Ltd.) was added 14 g of methylhexahydrophthalic anhydride (manufactured by Wako Pure Chemical Industries Ltd.), and then blended by 0.028 g of 1,8-diazabicyclo[5.4.0]undeca-7-en (manufactured by Sigma Aldrich Japan K.K.). The homogenously mixed material thus obtained was charged into a sealed Teflon (trademark) spacer, gradually heated in an oven till 130° C. for 3 hours, and then gradually cooled to room temperature to obtain a sample in the plate shape. The evaluation results on the physical properties of the sealant material for a semiconductor and of the cured product thus obtained are shown in Table 1.

TABLE 1

| | | | | | | Comparative |
|---|---|---|---|---|---|---|
| | Example 1 | Example 2 | Example 3 | Example 4 | Example 5 | Example 1 |
| Material (g) | | | | | | |
| (A) (Meth)acrylate compounds | | | | | | |
| (3-Acryloxy-2-hydroxypropyl)-terminated | | | 25 | | | |
| polydimethylsiloxane (a-1) | | | | | | |
| Hydrogenated polybutadiene diacrylate (a-2) | | 25 | | | | |
| Stearyl methacrylate (a-2) | | | | 20 | | |
| Polyethylene glycol #400 dimethacrylate (a-3) | 25 | | | 5 | 12.5 | |
| (B) (Meth)acrylate compounds | | | | | | |
| 1-Adamantyl methacrylate | 25 | 25 | 25 | 25 | 12.5 | |
| 1-Adamantyl methacrylate: for pre-polymerization | | | | | 12.5* | |
| (C) Radical polymerization initiators | | | | | | |
| Perhexa HC | 0.2 | 0.2 | 0.2 | 0.2 | 0.2 | |
| Peroyl TCP | 0.2 | 0.2 | 0.2 | 0.2 | 0.2 | |
| (Others) | | | | | | |
| (D) Methoxypolyethylene glycol #400 methacrylate: for | | | | | 12.5* | |
| pre-polymerization | | | | | | |
| Bisphenol A liquid epoxy resin | | | | | | 14 |
| Methylhexahydrophthalic anhydride | | | | | | 14 |
| 1,8-diazabicyclo[5.4.0]undeca-7-en | | | | | | 0.028 |
| Evaluation of physical properties | | | | | | |
| (1) Total light transmittance (%) | 90 | 89 | 89 | 89 | 90 | 86 |
| ΔTotal light transmittance (%): 140° C., 100 hr | 2.0 | 0.9 | 0.8 | 0.8 | 2.1 | 2.0 |
| (2) Weatherability test (measurement of yellow index) | | | | | | |
| ΔYI¹: Weatherability (UV light) | 0.1 | 0.1 | 0.1 | 0.1 | 0.1 | 12.0 |
| ΔYI²: Heat resistance (140° C., 100 hr) | 2.0 | 1.5 | 0.7 | 1.8 | 2.2 | 18.0 |
| (3) Haze | | | | | | |
| Initial Haze (%) | 3.2 | 3.5 | 3.4 | 3.3 | 3.0 | 4.1 |
| ΔHaze (%): 140° C., 100 hr | 0.5 | 0.1 | 0.2 | 0.2 | 0.6 | 21.0 |
| (4) Adhesion test | | | | | | |
| Number of adhered reflectors (per 10 reflectors) | 10 | 10 | 10 | 10 | 10 | 8 |

### INDUSTRIAL APPLICABILITY

The sealant material for an optical semiconductor of the present invention provides a cured product having excellent characteristics in transparency, stability to UV light and heat, yellowing resistance, and adhesion performance, and thus may be suitably used as a sealant material for a light emitting element, a light receiving element and the like in an optical semiconductor device (a semiconductor light emitting device), especially as a transparent sealant material for the optical semiconductors such as LED and the like.

1. A sealant material for an optical semiconductor, comprising:
(A) one or more kinds of a (meth)acrylate compound selected from a (meth)acrylate-modified silicone oil, a long chain alkyl (meth)acrylate, and a polyalkylene glycol(meth)acrylate having the number average molecular weight of 400 or more;
(B) a (meth)acrylate compound having an ester bond with an alicyclic hydrocarbon group having 6 or more carbon atoms; and
(C) a radical polymerization initiator.

2. The sealant material for an optical semiconductor according to claim 1, wherein the component (B) is a (meth)acrylate compound having an ester bond with one or more kinds of an alicyclic hydrocarbon group selected from an adamantyl group, a norbornyl group, an isobornyl group, and a dicyclopentanyl group.

3. The sealant material for an optical semiconductor according to claim 1, wherein the component (A) is hydrogenated polybutadiene diacrylate and/or polyethylene glycol di(meth)acrylate having the number average molecular weight of 400 or more.

4. An optoelectronic conversion element comprising using the sealant material for an optical semiconductor according to claim 1.

5. An optoelectronic conversion device comprising the optoelectronic conversion element according to claim 4.
